(19) United States
(12) Patent Application Publication
(10) Pub. No.: US 2012/0022734 A1
(43) Pub. Date: Jan. 26, 2012

(54) HYBRID ELECTRIC WORKING VEHICLE AND CONTROL METHOD THEREOF

(76) Inventors: Jung Woong CHOI, Suwon-si (KR); Sang Hyun KIM, Anyang-si (KR); Yong Joo KIM, Gunpo-si (KR)

(21) Appl. No.: 13/171,949

(22) Filed: Jun. 29, 2011

(30) Foreign Application Priority Data
Jul. 23, 2010 (KR) 10-2010-0071210

(51) Int. Cl. B60L 15/20; H02P 6/06

(52) U.S. Cl. 701/22; 318/139; 180/65.265

(57) ABSTRACT

The present disclosure relates to a hybrid working vehicle which determines the change of load by using a displacement of a flyweight or flyball in a governor, and controls a motor-generator according to the change of load, and a control method thereof. The hybrid working vehicle detects the change of load based on the displacement of the flyweight or flyball measured by a displacement measuring device, operates a motor-generator as a motor to supplement the power in a case where the load increases, and operates the motor-generator as an electric generator to collect energy in a case where the load decreases. In this way, revolution per minute (RPM) of a diesel engine may be detected rapidly and accurately based on the displacement of the flyweight or flyball without installing any complicated apparatus such as a torque measuring device which measures torque of a load, and accordingly controls the motor-generator so as to enhance the energy efficiency of the hybrid working vehicle and to improve the comfortable feeling of a driver.

### CROSS-REFERENCE TO RELATED APPLICATION

This application claims priority to Korean Patent Application No. 10-2010-0071210, filed on Jul. 23, 2010, and all the benefits accruing therefrom under 35 U.S.C. §119, the contents of which in its entirety are herein incorporated by reference.

### BACKGROUND

1. Field

The present disclosure relates to a hybrid working vehicle including a diesel engine and a motor-generator and a control method thereof.

2. Description of the Related Art

Recently, hybrid electric vehicles are actively studied to reduce energy and decrease exhaust gas. Hybrid vehicles are classified into series hybrid electric vehicles which operate an electric generator by an engine and operates an electric motor by the electric power, parallel hybrid electric vehicles which supplements the output of the engine by using an electric motor, and mixed hybrid electric vehicles which use both of the above methods.

Such hybrid electric vehicles may be applied as working vehicles which are used at construction sites. A working vehicle is operated while its engine has a fixed RPM due to the nature of its job. However, if the load applied to the engine abruptly increases or decreases, revolution per minute (RPM) of the engine also rapidly increases or decreases. Therefore, the efficiency of the engine is deteriorated, the fuel is more consumed, and the vehicle becomes inconvenient.

In order to solve these problems, in the conventional art, a motor-generator is operated as a motor in a case where the measured torque of the load is greater than the torque corresponding to the set RPM of the engine, and a motor-generator is operated as an electric generator in a case where the torque of the load is smaller than the torque corresponding to the set RPM of the engine. However, if this method is used, the equipment becomes complicated since separate devices such as a torque measuring device are necessary. In addition, due to external factors such as the friction between the engine and the load, there is a limit in controlling the internal combustion engine in an optimal state suitable for the characteristics of the load.

### SUMMARY

The present disclosure is directed to providing a hybrid working vehicle which determines the change of load by using a displacement of a flyweight or a flyball in a governor and controls a motor-generator corresponding to the change of load, and a control method thereof.

In one aspect, there is provided a hybrid working vehicle, which includes: a diesel engine which generates power; a revolution per minute (RPM) setting device which sets RPM of the diesel engine; a governor which controls an amount of injected fuel, supplied to the diesel engine, according to the RPM set by the RPM setting device; a displacement measuring device which measures a displace of a flyweight or flyball in the governor; a motor-generator which is connected to the same shaft as an output shaft of the diesel engine and is operated as a motor or an electric generator; and a control device which controls the RPM setting device to operate the diesel engine according to a preset working RPM and which operates the motor-generator as a motor or an electric generator by using the displacement of the flyweight or flyball, measured by the displacement measuring device.

The control device may determine that the RPM of the diesel engine is smaller than the working RPM in a case where the flyweight or flyball becomes closer to a shaft of the governor, and may determine that the RPM of the diesel engine is greater than the working RPM in a case where the flyweight or flyball becomes away from the shaft of the governor, based on the location of the flyweight or flyball when the diesel engine is operated according to the working RPM.

The hybrid working vehicle according to this aspect may further include a transmission which converts and outputs the power generated from the diesel engine or the motor-generator at a predetermined speed ratio.

The hybrid working vehicle according to this aspect may further include a clutch for disconnecting the power between the diesel engine or the motor-generator and the transmission.

The hybrid working vehicle according to this aspect may further include a battery which supplies a stored electric energy to the motor-generator or which receives and stores an electric energy generated by the motor-generator.

The hybrid working vehicle according to this aspect may further include an auxiliary battery which supplies a stored electric energy to the motor-generator or which receives and stores an electric energy generated by the motor-generator, wherein the auxiliary battery has an instant charging ability or an instant discharging ability with respect to large power.

The hybrid working vehicle according to this aspect may further include an electricity converting device which converts the electric energy generated by the motor-generator to be suitable for the battery or the auxiliary battery.

In another aspect, there is provided a control method of a hybrid working vehicle which includes a diesel engine and a motor-generator, the method comprising: measuring a displacement of a flyweight or flyball in a governor which controls an amount of injected fuel supplied to the diesel engine; determining whether RPM of the diesel engine is greater or smaller than a preset working RPM of the diesel engine, by using the measured displacement of the flyweight or flyball; and operating the motor-generator as a motor if it is determined that the RPM of the diesel engine is smaller than the working RPM, and operating the motor-generator as an electric generator if it is determined that the RPM of the diesel engine is greater than the working RPM.

The determining whether the RPM of the diesel engine is greater or smaller than the working RPM by using the displacement of the flyweight or flyball includes: determining that the RPM of the diesel engine is smaller than the working RPM in a case where the flyweight or flyball becomes closer to a shaft of the governor, and determining that the RPM of the diesel engine is greater than the working RPM in a case where the flyweight or flyball becomes away from the shaft of the governor, based on the location of the flyweight or flyball when the diesel engine is operated according to the working RPM.

Since the motor-generator is operated as a motor or an electric generator according to the load sensed by the displacement of a flyweight or flyball, the energy efficiency of a hybrid working vehicle may be improved, and the vehicle may become comfortable to drive in.

In addition, since the operation of the motor-generator is controlled using the change of load of a diesel engine, which is detected using the displacement of a flyweight or flyball, it is not necessary to install a separate device such as a load torque measuring device, and the hybrid working vehicle may be controlled more accurately without error caused by the friction between the diesel engine and the load torque measuring device. In particular, since the displacement of a flyweight or flyball may be detected instantly according to the change of load, energy may be supplied to or stored in the motor-generator more rapidly.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic control block diagram showing a hybrid working vehicle according to an exemplary embodiment of the present disclosure;

FIG. 2 is a schematic control block diagram showing a hybrid working vehicle according to another embodiment of the present disclosure;

FIG. 3 shows an example of a structure of a governor installed to the hybrid working vehicle according to an exemplary embodiment of the present disclosure;

FIG. 4 is a graph illustrating the operation of the motor-generator according to the change of load of the hybrid working vehicle according to an exemplary embodiment of the present disclosure; and

FIG. 5 is a flowchart illustrating a control method of the hybrid working vehicle according to an exemplary embodiment of the present disclosure.

### REFERENCE NUMERALS

10: diesel engine 12: governor
12a: flyweight 12b: control rack
14: displacement measuring device 16: RPM setting device
20: motor-generator 22: electricity converting device
24: battery 30: clutch
40: transmission 50: control device

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

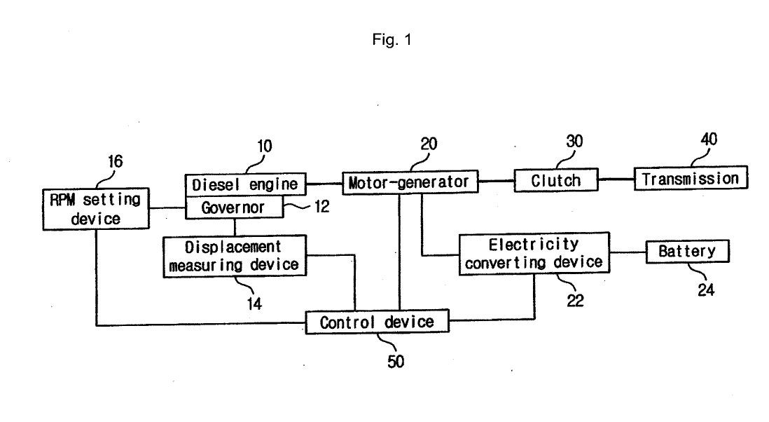

FIG. 1 is a schematic control block diagram showing a hybrid working vehicle according to an exemplary embodiment of the present disclosure.

The hybrid working vehicle of this embodiment includes a diesel engine 10, a governor 12, a displacement measuring device 14, a revolution per minute (RPM) setting device 16, a motor-generator 20, an electricity converting device 22, a battery 24, a clutch 30, a transmission 40, and a control device 50.

The diesel engine 10 is a kind of internal combustion engine which is applied to the hybrid working vehicle of this embodiment. The diesel engine 10 plays a role of converting thermal energy obtained by the combustion of fuel into kinetic energy and transmitting a driving force to the hybrid working vehicle.

The governor 12 plays a role of controlling RPM of the diesel engine 10 by adjusting the amount of injected fuel according to the load. The diesel engine 10 should maintain a stable RPM with respect to the change of load in order to stably control the rotation of the engine. In particular, since the amount of inhaling air of the diesel engine 10 is substantially consistent regardless of RPM of the engine, the output torque characteristics are determined depending on the amount of injected fuel. In addition, the governor 12 is connected to an injecting amount control unit of a fuel injection pump body to control the amount of injected fuel according to the RPM and load of the diesel engine 10.

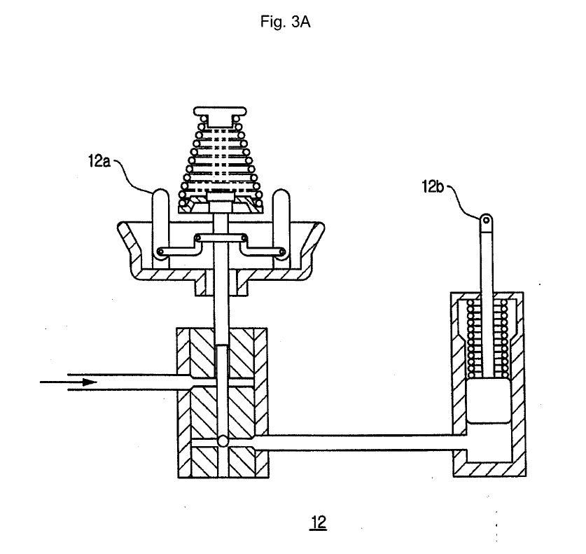

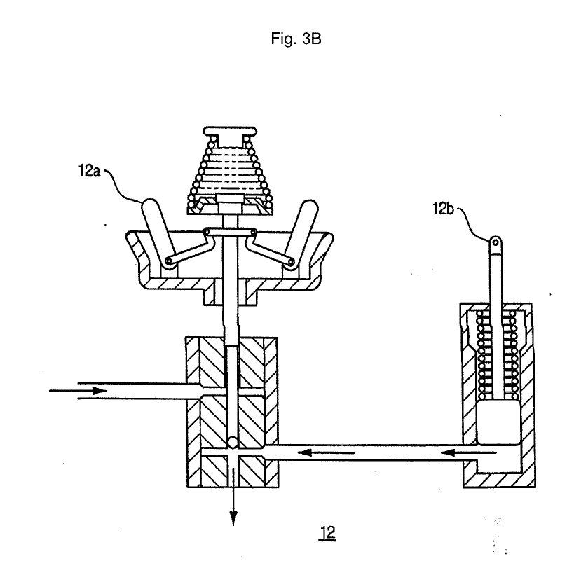

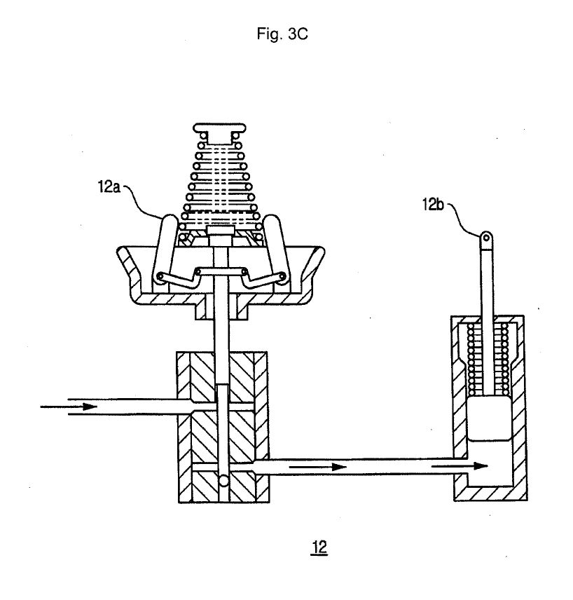

The displacement measuring device 14 plays a role of detecting the displacement of a flyweight or flyball in the governor 12 which will be described later in connection with FIG. 3. The flyweight 12a or flyball becomes wider or narrower depending on the RPM of the diesel engine 10 which varies according to the size of the load. Therefore, it is determined whether the load is greater or smaller in comparison to the load corresponding to a preset RPM of the diesel engine 10, by measuring the displacement of the flywheel or flyball. It will be described later in more detail.

The RPM setting device 16 sets RPM of the diesel engine 10. In other words, the RPM setting device 16 adjusts the amount of injected fuel of the diesel engine 10 to determine RPM of the diesel engine 10. At this time, the governor 12 takes charge of consistently maintaining RPM of the diesel engine 10.

The motor-generator 20 is connected to the same shaft as an output shaft of the diesel engine 10. The motor-generator 20 is operated as an electric generator to generate electricity or operated as a motor to generate a motive power, according to the signal of the control device 50 which will be described later.

The electricity converting device 22 plays a role of converting electric energy generated by the motor-generator 20 to be suitable for the battery 24. The electricity converting device 22 is generally composed of an inverter or converter circuit or the like.

The battery 24 plays a role of storing the electric energy converted by the electricity converting device 22 or supplying the stored electric energy to the motor-generator 20.

The transmission 40 plays a role of converting and outputting the power generated by the diesel engine 10 or the motor-generator 20 at a predetermined speed ratio. The clutch 30 plays a role of disconnecting the power between the diesel engine 10 or the motor-generator 20 and the transmission 40.

The control device 50 plays a role of receiving a signal sent from the displacement measuring device 14 and a signal sent from the RPM setting device 16 or the electricity converting device 22 to determine a demand of a driver and controlling the motor-generator 20 according to the situation. Detailed operations of the control device 50 will be described later.

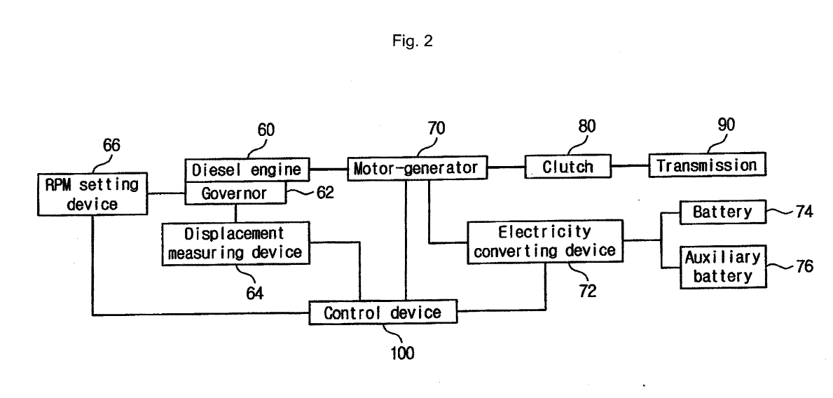

FIG. 2 is a schematic control block diagram showing a hybrid working vehicle according to another embodiment of the present disclosure.

The hybrid working vehicle of FIG. 2 further includes an auxiliary battery 76, in addition to the hybrid working vehicle of FIG. 1. In other words, the hybrid working vehicle of FIG. 2 includes a diesel engine 60, a governor 62, a displacement measuring device 64, a RPM setting device 66, a motor-generator 70, an electricity converting device 72, a battery 74, an auxiliary battery 76, a clutch 80, a transmission 90, and a control unit 100. A component corresponding to that of FIG. 1 but designated by a different reference numeral will not be described again.

In FIG. 2, the electricity converting device 72 is composed of an inverter or converter circuit or the like, similar to that of FIG. 1 and plays a role of converting the electric energy generated by the motor-generator 70 to be suitable for the battery 74 and the auxiliary battery 76. The auxiliary battery 76 has a smaller capacity than the battery 74 but has an excellent instant charging or discharging ability, for example instantly outputting a great power or absorbing an electric impact such as a surge voltage. An ultra capacity may be used as the auxiliary battery 76.

For example, a great load may be frequently applied to or released from a farm tractor or a construction machine according to the ground condition while the farm tractor or the construction machine is operating. At this time, since a short-time large power is necessary or generated according to the change of a large load, the durability or safety of a secondary battery may be deteriorated by the large power. Therefore, the battery 74 corresponding to the secondary battery is used when successive charging or discharging, and the auxiliary battery 76 such as an ultra capacitor is used for instant charging or discharging.

FIGS. 3a to 3c are an example of a structure of the governor installed to the hybrid working vehicle according to an exemplary embodiment of the present disclosure.

The governor is generally classified into a roll safety type governor, a disk type governor, and a flyball type governor depending on its structure. The roll safety type governor or the disk type governor includes a flyweight, and the flyball type governor includes a flyball. The flyweight or flyball becomes wider or narrower according to RPM of the diesel engine. The governor controls the amount of fuel supplied to the diesel engine according to the displacement of the flyweight or flyball so that the RPM of the diesel engine is consistently maintained at a predetermined speed. Hereinafter, the disk type governor will be described with reference to FIG. 3.

In FIG. 3, the governor 12 includes a control rack 12b which controls an amount of fuel supplied to the diesel engine 10 according to the displacement of the flyweight 12a which becomes wider or narrower according to the RPM of the diesel engine 10 to change its location.

If the set RPM is identical to an actual RPM as in FIG. 3a, the flyweight 12a is kept at a neutral location. If an actual RPM is greater than the set RPM as in FIG. 3b, the flyweight 12a becomes wider to close a valve so that the amount of supplied fuel decreases. If an actual RPM is smaller than the set RPM as in FIG. 3c, the flyweight 12a becomes narrower to open the valve so that the engine recovers its original RPM. In this way, the governor 12 controls the amount of fuel by means of mechanical or hydraulic devices so that the set RPM may be maintained by the RPM controlling device.

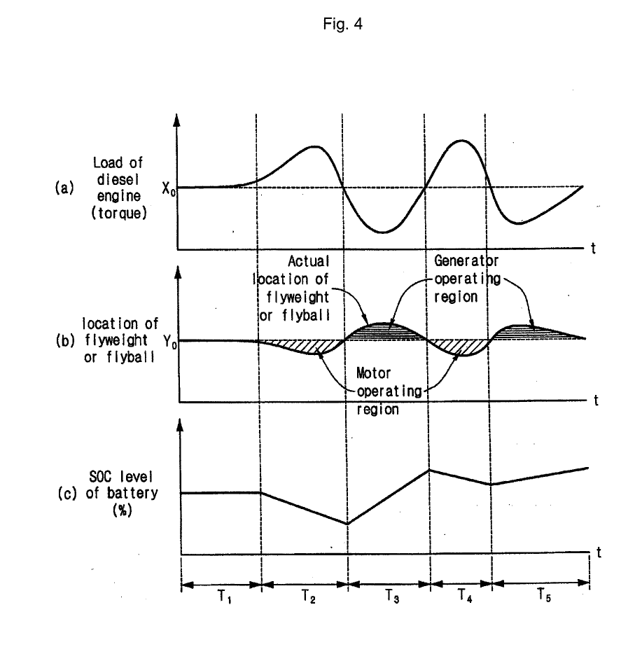

The displacement measuring device 14 described above measures a displacement of the flyweight 12a or the flyball (not shown). Based on the measured displacement of the flyweight 12a or flyball, it may be determined whether a load is applied to or released from the diesel engine 10. At this time, the change of load of the diesel engine 10 is determined based on the displacement of the flyweight 12a or flyball. In other words, if the load of the diesel engine 10 increases based on the load corresponding to a preset working RPM, the RPM of the diesel engine 10 becomes smaller than the working RPM, while, if the load of the diesel engine 10 decreases, the RPM of the diesel engine 10 becomes greater than the working RPM. Therefore, it may be determined whether the load increases or decreases, by comparing the RPM of the diesel engine 10 with the working RPM. At this time, the change of RPM of the diesel engine 10 may be checked from the displacement of the flyweight 12a or flyball as mentioned above. Hereinafter, operations of the hybrid working vehicle according to the exemplary embodiment of the present disclosure will be described in detail with reference to FIG. 4.

FIG. 4 is a graph illustrating operations of the motor-generator according to the change of load of the hybrid working vehicle according to the exemplary embodiment of the present disclosure.

(a) of FIG. 4 is a graph showing the change of load according to an operating region of the diesel engine 10, (b) of FIG. 4 is a graph showing a displacement of the flyweight 12a or flyball according to the operating region of the diesel engine 10, and (c) of FIG. 4 is a graph showing the change of state of charge (SOC) level of the battery 24 according to the operating region of the diesel engine 10.

Referring to (a) of FIG. 4, the load of the diesel engine 10 has a value identical to X₀ corresponding to the preset working RPM of the diesel engine 10 in a T₁ region, increases to be greater than X₀ in a T₂ region, decreases to be smaller than X₀ in a T₃ region, increases to be greater than X₀ in a T₄ region, and decreases to be smaller than X₀ in a T₅ region. In other words, the actual load increases to be greater than the load corresponding to the preset working RPM of the diesel engine 10 in the T₂ and T₄ regions, and the actual load decreases to be smaller in the T₃ and T₅ regions. This phenomenon occurs since the load may abruptly increase or decrease due to an obstacle or a ground condition while the hybrid working vehicle such as a tractor or a construction machine is operating.

If the load increases or decreases to be greater or smaller than the load corresponding to the preset working RPM of the diesel engine 10, the location of the flyweight 12a or flyball of the diesel engine 10 also changes. Referring to (b) of FIG. 4, in the T₂ and T₄ regions where the actual load is greater than the load corresponding to the working RPM of the diesel engine 10, an actual location of the flyweight 12a or flyball in the governor 12 becomes lower than the location Y₀ of the flyweight 12a or flyball corresponding to the preset working RPM so that the flyweight 12a or flyball becomes close to the shaft of the governor 12. In the T₃ and T₅ regions where the actual load is smaller than the load corresponding to the working RPM of the diesel engine 10, an actual location of the flyweight 12a or flyball in the governor 12 becomes higher than the location Y₀ of the flyweight 12a or flyball corresponding to the preset working RPM so that the flyweight 12a or flyball becomes away from to the shaft of the governor 12.

If the RPM of the diesel engine 10 changes as the load changes while a hybrid working vehicle is operating, an operating speed of the hybrid working vehicle may abruptly change, which deteriorates the comfortable driving and the fuel efficiency. In addition, the energy generated by the abrupt change of RPM of the diesel engine 10, which is caused by the increase or decrease of load, may be not collected, resulting in deteriorated energy efficiency.

The hybrid working vehicle according to the exemplary embodiment of the present disclosure collects the energy generated by the abrupt change of RPM of the diesel engine and uses the collected energy as an auxiliary power by means of the motor-generator 20. In other words, if the load of the diesel engine 10 increases as an amount of load abruptly increases, the motor-generator 20 is operated as a motor to supplement the power so that the working RPM of the diesel engine 10 is restored. If the load of the diesel engine 10 decreases as an amount of load abruptly decreases, the motor-generator 20 is operated as an electric generator to collect the energy generated by the rotation of the diesel engine 10 so that the battery 24 is charged with the collected energy and therefore the working RPM of the diesel engine 10 is restored.

The following description refers to FIG. 4. If the actual load increases to be greater than the load corresponding to the preset working RPM of the diesel engine 10 (T₂ and T₄ regions), the RPM of the diesel engine 10 becomes lower than the working RPM, and thus the flyweight 12a or flyball in the governor 12 becomes narrower inwards. At this time, the control device 50 transmits the electric energy stored in the battery 24 to the motor-generator 20 through the electricity converting device 22 to generate a motive power. By using the auxiliary power generated by the motor-generator 20, the diesel engine 10 may be operated while maintaining the working RPM determined by the RPM setting device 16 without consuming more fuel and without reducing RPM.

On the contrary, if the actual load decreases to be smaller than the load corresponding to the preset working RPM of the diesel engine 10 (T₃ and T₅ regions), the RPM of the diesel engine 10 becomes greater than the working RPM. The load generated by the hybrid working vehicle may continuously change as if moving up or down on a hill, but the load may be instantly applied or released on occasions. If the load is instantly released, the RPM of the diesel engine 10 instantly increases due to the rotary inertia so that the flyweight 12a or flyball in governor 12 becomes wider outwards. At this time, the control device 50 operates the motor-generator 20 as an electric generator to prevent the RPM of the diesel engine from rapidly increasing and to collect the wasted energy. The generated electricity is stored in the battery 24 through the electricity converting device 22.

The control device 50 may determine whether an actual load increases or decreases based on the location of the flyweight 12a or flyball in the governor 12 of the diesel engine 10, which is set by the RPM setting device 16. In other words, the change of RPM of the diesel engine 10 according to the increase or decrease of an actual load is determined from the displacement of the flyweight 12a or flyball in the governor 12, and the increase or decrease of load may be determined therefrom. If the actual load increases, the control device 50 operates the motor-generator 20 as an electric generator to prevent the RPM of the diesel engine 10 from rapidly increasing, and stores the electric energy in the battery. In addition, if an actual load decreases, the control device 50 operates the motor-generator 20 as a motor to supplement the deficient power of the diesel engine 10 so that the RPM of the diesel engine 10 is consistently maintained.

In (c) of FIG. 4, it could be found that the SOC level decreases in the T₂ and T₄ regions where the motor-generator 20 is operated as a motor, and the SOC level increases in the T₃ and T₅ regions where the motor-generator 20 is operated as an electric generator. The control device 50 controls the motor-generator 20 as shown in FIG. 4 according to the change of an actual load, and controls the SOC level of the battery 24 to be always maintained within a predetermined range. If the SOC level is equal to or smaller than a certain value and if the clutch 30 intercepts the power transmission or the transmission 40 is in a neutral location, the motor-generator 20 is operated as an electric generator as long as the efficiency of the diesel engine 10 is not deteriorated below a certain level, so that the SOC level is restored within a predetermined range.

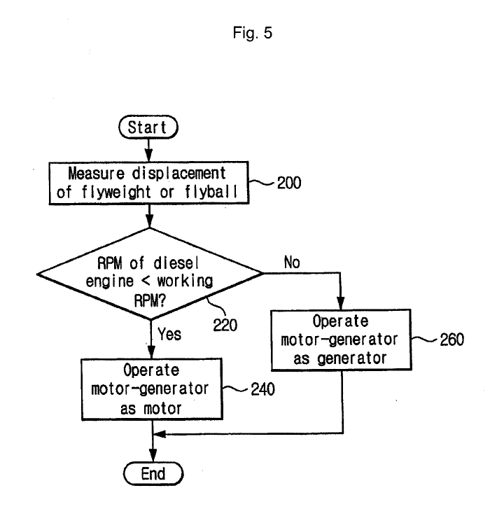

FIG. 5 is a flowchart illustrating a control method of a hybrid working vehicle according to an exemplary embodiment of the present disclosure.

While the hybrid working vehicle is operating, the displacement measuring device 14 measures a displacement of the flyweight 12a or flyball in the governor 12 (200). At this time, the control device 50 determines whether an actual load increases or decreases, by using the displacement of the flyweight 12a or flyball, measured by the displacement measuring device 14. The RPM of the diesel engine 10 changes according to the increase or decrease of the actual load, and the location of the flyweight 12a or flyball changes according to the change of RPM of the diesel engine 10. In other words, the control device 50 determines whether the RPM of the diesel engine 10 is smaller than a preset working RPM by using the location of the flyweight 12a or flyball (220). If it is determined that the RPM of the diesel engine 10 is smaller than the working RPM, it means that the actual load increases, so the control device 50 operates the motor-generator 20 as a motor (240). Accordingly, the RPM of the diesel engine 10 is restored to the working RPM. In addition, if it is determined that the RPM of the diesel engine 10 is greater than the working RPM, it means that the actual load decreases, so the control device 50 operates the motor-generator 20 as an electric generator (260). Accordingly, the RPM of the diesel engine 10 is restored to the working RPM, and the energy created by the abrupt increase of RPM of the diesel engine 10 is stored in the battery 24 as an electric energy form.

In this way, the hybrid working vehicle of this embodiment collects the energy wasted by the change of load to improve the energy efficiency, and the RPM of the diesel engine 10 is maintained at a preset working RPM, which consistently maintains a working speed, improves the comfortable feeling of a driver and improves the fuel efficiency.

In addition, the configuration becomes simple since it is not necessary to separately install a torque measuring device which measures a torque applied to a load. Moreover, since the change of load is detected and determined by sensing the displacement of the flyweight 12a or flyball in the governor 12 of diesel engine 10, any error such as a friction between the diesel engine 10 and the load does not give any influence, which allows more accurate control. In particular, since the load may instantly increase or decrease, energy may be supplied to or stored in rapidly and accurately by using the motor-generator 20.

The above configuration and control method may be applied to not only a parallel hybrid working vehicle which uses the motor-generator as an auxiliary power source of an internal combustion engine but also a mixed hybrid working vehicle which uses the diesel engine and the motor as complicated power sources.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A hybrid working vehicle, comprising:
a diesel engine which generates power;
a revolution per minute (RPM) setting device which sets RPM of the diesel engine;
a governor which controls an amount of injected fuel, supplied to the diesel engine, according to the RPM set by the RPM setting device;
a displacement measuring device which measures a displace of a flyweight or flyball in the governor;
a motor-generator which is connected to the same shaft as an output shaft of the diesel engine and is operated as a motor or an electric generator; and
a control device which controls the RPM setting device to operate the diesel engine according to a preset working RPM and which operates the motor-generator as a motor or an electric generator by using the displacement of the flyweight or flyball, measured by the displacement measuring device.

2. The hybrid working vehicle according to claim 1, wherein the control device operates the motor-generator as a motor in a case where the flyweight or flyball becomes closer to a shaft of the governor, and operates the motor-generator as an electric generator in a case where the flyweight or flyball becomes away from the shaft of the governor, based on the location of the flyweight or flyball when the diesel engine is operated according to the working RPM.

3. The hybrid working vehicle according to claim 1, further comprising a transmission which converts and outputs the power generated from the diesel engine or the motor-generator at a predetermined speed ratio.

4. The hybrid working vehicle according to claim 3, further comprising a clutch for disconnecting the power between the diesel engine or the motor-generator and the transmission.

5. The hybrid working vehicle according to claim 1, further comprising a battery which supplies a stored electric energy to the motor-generator or which receives and stores an electric energy generated by the motor-generator.

6. The hybrid working vehicle according to claim 5, further comprising an auxiliary battery which supplies a stored electric energy to the motor-generator or which receives and stores an electric energy generated by the motor-generator, wherein the auxiliary battery has an instant charging ability or an instant discharging ability with respect to large power.

7. The hybrid working vehicle according to claim 5, further comprising an electricity converting device which converts the electric energy generated by the motor-generator to be suitable for the battery.

8. The hybrid working vehicle according to claim 6, further comprising an electricity converting device which converts the electric energy generated by the motor-generator to be suitable for the auxiliary battery.

9. A control method of a hybrid working vehicle which includes a diesel engine and a motor-generator, the method comprising:
measuring a displacement of a flyweight or flyball in a governor which controls an amount of injected fuel supplied to the diesel engine;
determining whether RPM of the diesel engine is greater or smaller than a preset working RPM of the diesel engine, by using the measured displacement of the flyweight or flyball; and
operating the motor-generator as a motor if it is determined that the RPM of the diesel engine is smaller than the working RPM, and operating the motor-generator as an electric generator if it is determined that the RPM of the diesel engine is greater than the working RPM.

10. The control method of a hybrid working vehicle according to claim 9, wherein the determining whether the RPM of the diesel engine is greater or smaller than the working RPM by using the displacement of the flyweight or flyball includes:
determining that the RPM of the diesel engine is smaller than the working RPM in a case where the flyweight or flyball becomes closer to a shaft of the governor, and determining that the RPM of the diesel engine is greater than the working RPM in a case where the flyweight or flyball becomes away from the shaft of the governor, based on the location of the flyweight or flyball when the diesel engine is operated according to the working RPM.
